(19) United States
(12) Patent Application Publication
(10) Pub. No.: US 2026/0167082 A1
(43) Pub. Date: Jun. 18, 2026

(54) OIL DELIVERY PROCESS WITH BULK OIL QUALITY CONTROL

(71) Applicant: CARGILL, INCORPORATED, Wayzata, MN (US)

(72) Inventor: Greg MITCHELL, Wayzata, MN (US)

(21) Appl. No.: 18/711,251

(22) PCT Filed: Nov. 17, 2022
(86) PCT No.: PCT/US2022/080005

§ 371 Date: May 17, 2024

Related U.S. Application Data
(60) Provisional application No. 63/282,791, filed on Nov. 24, 2021.

(51) Int. Cl. F16K 1/12; B01D 17/02; B62D 5/06; B65D 88/02; B65D 88/12; B67D 7/34; C09K 8/34

(52) U.S. Cl. CPC B60P 3/2245; B67D 7/0288; B67D 7/348

(57) ABSTRACT

A transport system (200) for delivering fluids is provided. The transport system includes a chassis (202) configurable as a frame of a vehicle. The transport system additionally includes a first fluid storage tank (206) positioned on and coupled to the chassis and configured to receive a first fluid; and a first fluid outlet conduit (208) fluidly coupled to the first fluid storage tank and configured to receive the first fluid from the storage tank to provide to a first fluid storage location (220). In addition, the transport system further includes a second fluid storage tank (232) positioned on and coupled to the chassis and configured to receive second fluid from a second fluid storage location (234); and a second fluid inlet conduit (236) fluidly coupled to the second fluid storage tank and configured to receive the second fluid from a second fluid storage location and provide the second fluid to the second fluid storage tank.

### CROSS-REFERENCE TO RELATED APPLICATIONS

The present application claims priority to U.S. Provisional Application No. 63/282,791 filed Nov. 24, 2021, the entire contents of which are incorporated herein by reference.

### FIELD

The present disclosure relates generally to oil delivery and processing. Particularly, the disclosure relates to edible oil, including for fresh and/or used cooking oil, storage, delivery, and processing.

### BACKGROUND

Various techniques have been employed for bulk delivery of edible oils, for customer usage. Edible oil includes oils and fats used for cooking and frying in food processing, including at eateries, food preparation sites, and households. Edible oils can include vegetable and animal fats, for example. The efficiency of edible oil, namely cooking oil, delivery depends at least in part on having a suitable infrastructure.

### SUMMARY OF THE INVENTION

One aspect of the present disclosure relates to a system for storing fluid includes a fluid delivery controller; a storage tank for storing a fluid and configured to be communicated with the fluid delivery controller, and conduits. The conduits include an upstream conduit, a downstream conduit, and a plurality of discharge conduits. The upstream conduit is fluidly coupled to the storage tank and configured to transport the fluid from an upstream location to the storage tank. The downstream conduit is fluidly coupled to the storage tank and is configured to transport the fluid from the storage tank. The plurality of discharge conduits are fluidly coupled to the downstream conduits and configured to receive the fluid from the storage tank and configured to provide the fluid to a system downstream of the plurality of discharge conduits.

Another aspect relates to a transport system for delivering fluids, the transport system comprising a chassis; a first fluid storage tank positioned on and coupled to the chassis and configured to receive a first fluid; a first fluid outlet conduit fluidly coupled to the first fluid storage tank and receiving the first fluid from the storage tank to provide to a first fluid storage location; a second fluid storage tank positioned on and coupled to the chassis and configured to receive second fluid from a second fluid storage location; and a second fluid inlet conduit fluidly coupled to the waste fluid storage tank and configured to receive the second fluid from a second fluid storage location and providing to the second fluid storage tank.

Another aspect relates to a system for delivering fluid. The system includes a storage system for storing fluid including a first fluid first storage tank configured to store the first fluid; an upstream conduit fluidly coupled to the first fluid first storage tank and configured to transport the first fluid from an upstream location to the first fluid first storage tank; a downstream conduit fluidly coupled to the first fluid first storage tank, the downstream conduit configured to transport the first fluid from the first fluid first storage tank; and a plurality of discharge conduits fluidly coupled to the downstream conduits, the plurality of discharge conduits configured to receive the first fluid from the first fluid first storage tank and configured to provide the first fluid to a system downstream of the plurality of discharge conduits; and a second fluid first storage tank. The system further includes a transport system for delivering fluid comprising a chassis; a first fluid second storage tank positioned on and coupled to the chassis and configured to receive the first fluid from the first fluid first storage tank; a first fluid outlet conduit fluidly coupled to at least one of the plurality of discharge conduits and to the first fluid second storage tank, the first fluid outlet conduit configured to receive first fluid from the at least one of the plurality of discharge conduits and provide the first fluid to the first fluid second storage tank; a second fluid second storage tank positioned on and coupled to the chassis and configured to discharge second fluid to the second fluid first storage tank; and a second fluid outlet conduit fluidly coupled to the second fluid first storage tank and the second fluid storage tank, the second fluid outlet conduit configured to receive second fluid from the second fluid second storage tank and provide the second fluid to the second fluid first storage tank.

Another aspect relates to a method of delivering oil using any of the systems described herein. Further, in some aspects, a method of storing fluid is provided. The method includes providing a fluid bulk transporter wherein the fluid bulk transporter is configured to contain therein the fluid. The method further includes coupling, via a conduit, the fluid bulk transporter to a storage tank. Additionally, the method includes “operating” as follows (1) operating, via a controller, an inlet control valve from a first position to a second position to facilitate flow of fluid from the fluid bulk transporter to the storage tank; and (2) operating, via the controller, the inlet control valve from the second position to the first position to prevent flow of the fluid between the fluid bulk transporter and the storage tank.

Yet another aspect relates to a non-transitory computer readable medium configured to store instructions which, when executed by a processor of a fluid delivery controller, cause the fluid delivery controller to carry out operations comprising controlling oil delivery using any of the systems described herein.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appended at the end of this disclosure are contemplated as being part of the subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 depicts an exemplary system for storing oil according to an aspect.

FIG. 2 depicts an exemplary transport system for oil delivery according to an aspect.

FIG. 3 depicts an exemplary system for storing oil according to an aspect;

FIG. 4 depicts a method for delivering fluid to a distribution center;

FIG. 5 depicts a method for delivering fluid from a distribution center to a distribution center transport system;

FIG. 6 depicts a method of delivering fluid from transport system to an in-store system;

FIG. 7 depicts a method of delivering a second fluid from a UCO source tank to a transport system; and

FIG. 8 depicts a method of delivering a second fluid from a UCO source tank to a waste hauling tanker.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

The systems and methods described herein facilitate delivery of edible oils from a source to a destination in a manner that allows for reduced delivery costs without deteriorations in bulk oil quality. The implementations described herein facilitate oil delivery in an efficient manner while preserving bulk oil quality. The bulk oil as discussed herein can be edible oil.

As used herein, the term “edible oil” refers to a fat or oil that is suitable for human consumption. Edible oils are typically compositions including triacylglycerols (“TAG”). The edible oils may be obtained from plant (e.g., vegetables), animal, or microbial sources. By way of illustration, the edible oils, as described herein, include cooking oils (such as fresh and/or used cooking oils). The oil may include, but is not limited to, sunflower oil, citrus oil (such as lemon oil, orange oil, and the like or mixtures thereof), grape seed oil, sesame oil, peanut oil, mustard oil, nut oil (such as almond oil, cashew oil, walnut oil, hazelnut oil, macadamia oil, or mixtures thereof), corn oil, wheat kernel oil, rapeseed oil, safflower oil, flaxseed oil, soybean oil, canola oil, cottonseed oil, marine oil (such as fish oil, algal oil, fungal oil, or mixtures thereof), rice bran oil, olive oil, or mixtures of two or more thereof. The edible oil may be a high oleic edible oil, such as high oleic sunflower oil, high oleic citrus oil, high oleic grape seed oil, high oleic sesame oil, high oleic peanut oil, high oleic mustard oil, high oleic nut oil, high oleic corn oil, high oleic wheat kernel oil, high oleic rapeseed oil, high oleic safflower oil, high oleic flaxseed oil, high oleic soybean oil, high oleic canola oil, high oleic cottonseed oil, high oleic marine oil, or mixtures of two or more thereof. Edible oils as described herein can also be fats, including but not limited to, butter, lard, tallow, butter oil, cocoa butter, mango butter, shea butter, milk fat, coconut oil, palm oil, palm olein, palm kernel oil, shea oil, illipe oil, sal oil, kokum gurgi oil, mango kernel oil, hydrogenated vegetable oil (such as hydrogenated fractionated palm kernel oil, hydrogenated cottonseed oil, hydrogenated soybean oil, hydrogenated sunflower oil, hydrogenated canola oil, hydrogenated rapeseed oil, and the like or mixtures thereof), hydrogenated fish oil, or mixtures of two or more thereof. As used herein, “vegetable oils” refers to oils derived from vegetables and/or oil seeds. The edible oils as described herein may also be a hydrogenated edible oil, a chemically or enzymatically interesterified edible oil, a fractionated edible oil, or mixtures thereof.

Edible oils used for cooking food (e.g., frying food, such as in deep fat frying applications), can undergo a variety of degradation mechanisms as such oils age in use. Such degradation mechanisms may impact oil quality, and may include oxidative processes, hydrolysis, and pyrolysis, as illustrative examples. The edible oil used for cooking has typically undergone a series of different reactions induced by heating at which it is used (or becomes used cooking oil (UCO)), including polymerization, decomposition, and thermoxidation. These reactions form degradation compounds, such as polymerized triacylglycerols or “polymers”, oxidized TAG, diacylglycerols (DAG), monoacylglycerols (MAG), free fatty acids (FFA), and shorter chain volatile and non-volatile compounds. UCO may typically be characterized by analysis of the UCO's Total Polar Materials (TPM) content, polymer content, content of oxidized TAG, DAG, MAG, FFA content, and color.

As a non-limiting example, the degradation mechanisms and degradation compounds of edible oil can be determined by methods and systems described in U.S. Patent Publication 2020/0124582, which is herein incorporated by reference in its entirety for the techniques set forth therein, including, inter alia, spectroscopic evaluation techniques to evaluate edible oils.

By way of illustration, a “source” as referred to above may include a plant, such as a processing plant where various processing operations involving edible oil take place. A “destination” may include any intermediate or final delivery point from the source. As an example of an “intermediate” destination, a distribution center may be present in certain scenarios, as explained below. A “terminal” or “final” destination is the endpoint from the source. Such destinations may include restaurants, eateries, shopping malls containing food courts, rest centers, institutional campuses, etc. In some aspects, bulk oil is delivered via vehicles (e.g., trucks) to at least one fresh oil tank in a distribution center. Then, the oil in the at least one fresh oil tank is delivered to restaurants. Optionally, such delivery of oil may be accompanied with concurrently delivery of food and supplies. In some aspects, a system containing two stacked medium-sized tanks is installed in a restaurant for storing fresh oil and disposing of waste cooking oil, i.e., used cooking oil (UCO).

Speaking generally, at various restaurants, oil is packed in disposable plastic jugs-in-boxes (“JIBs”). A JIB typically has a volumetric capacity of about 5 gallons. The delivery footprint depends on the type of storage systems and quantities of oil that are typically provided to a destination. Typical storage systems have a significant footprint and may present sustainability issues from an environmental standpoint.

The techniques set forth herein in accordance with various aspects provide a reduced delivery footprint. Through a reduction in the use of JIBs, packing costs and environmental impacts may be reduced. Further, by combining oil delivery with food and supply delivery in tandem, more efficient use of small and medium sized tanks may be realized. Small and medium sized tanks may be used to store both fresh oil and waste oil. Further, storing fresh oil in small or medium sized tanks may allow for enhancement in bulk oil quality. Additionally, a reduction in tank space utilization may be realized.

Thousands of fast food restaurants (e.g., eateries, franchise locations, independent stores) are present in the United States. These restaurants may have considerable need for fresh oil, with average usage being more than a thousand pounds per month (e.g., 1,000-2,000 lbs. per month). Large quantities of waste oil (e.g., two thirds of the fresh oil, or more) may also be produced each month. Some restaurants store fresh oil and waste oil in large portable oil shuttle systems. For such shuttle systems, an oil handler service may have a facility with terminals which receive oil delivered via supply trucks from a supplier. Using delivery trucks, the oil handler service (e.g., a servicer or provider of oil handling services) may pump fresh oil to tanks in various stores on a periodic basis (e.g., every few weeks). The oil handler service may transfer oil from bulk or semi-bulk tanks in the restaurants to fryer systems therein, and further handle removal of UCO from the stores.

In some circumstances, large in situ storage is required at restaurants in order to store sufficient quantities of fresh cooking oil and/or provide adequate space for UCO. Such space requirements may depend on the delivery schedule and servicing frequency of the oil handler service. For example, if the oil handler service visits are infrequent, then larger storage may be needed. Further, there may be a disparity between the timing or frequency of the oil handler service visits for certain tasks (e.g., removal of edible oil, or transfer of edible oil from tanks to fryers) and tasks performed by other parties (e.g., a regular delivery of edible oil from another supplier).

Various restaurants or other establishments serving or selling food may use JIBs filled with oil at a supplier's packaging facilities. Such JIBs may be delivered with supplies to restaurants.

Various restaurants or other establishments serving food, in lieu of or in addition to JIBs, may include containers suitable for larger quantities of oil than can be stored in a JIB. Bulk storage tanks at the premises of a restaurant or other such establishment may have a variety of dimensions and configurations. In an aspect, a bulk storage tank as may be present at or provided to such a restaurant or other establishment is dimensioned to have a volumetric capacity between about 25 gallons to about 50 gallons, between about 50 gallons to about 100 gallons, between about 50 gallons to about 150 gallons, between about 150 gallons to about 200 gallons, between about 200 gallons to about 250 gallons, between about 250 gallons to about 300 gallons, between about 300 gallons to about 350 gallons, between about 350 gallons to about 400 gallons, or between about 400 gallons to about 500 gallons, for example.

Aspects set forth herein provide for processing of bulk fresh edible oil (e.g., fresh cooking oil) and used edible oil (e.g., UCO) at distribution centers with the capability to transport oils for delivery to and from stores, and to be used with in-store oil systems.

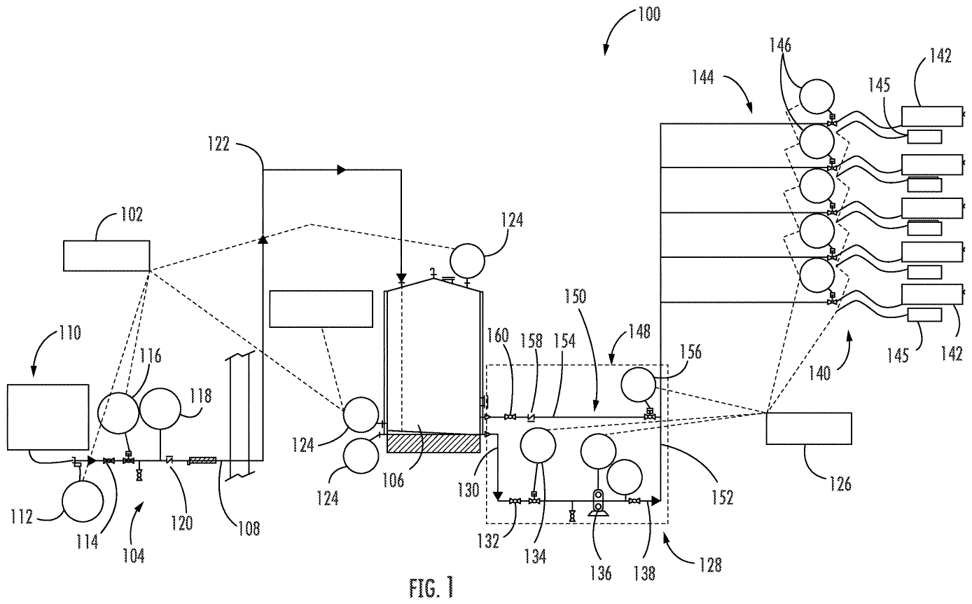

Such aspects are configured to be implemented in connection with storage tanks (e.g., bulk storage tanks, fresh fluid storage tank, etc.) and unloading/loading systems at distribution centers. For example, fresh oil may be filled into storage tanks at the facilities of a supplier. That oil may then be delivered and unloaded into bulk tanks at a distribution center. Referring to FIG. 1, a system 100 for storing fluid is shown, according to an example aspect. The system 100 for storing fluid includes a fluid delivery first controller 102 (e.g., an unload controller, etc.), configured to control the delivery of a first fluid (e.g., fresh cooking oil, first fresh fluid, etc.). The system 100 for storing fluid further includes an upstream conduit 104 (e.g., food grade hose, etc.) for transporting the first fluid to a storage tank 106, as described herein. The upstream conduit 104 includes an upstream conduit upstream section 108 which is fluidly coupled to a fluid bulk transporter 110 (e.g., fresh oil bulk trailer, fresh oil bulk tanker, tanker truck, etc.) and receives the first fluid from the fluid bulk transporter 110. One or more fluid bulk transporters 110 which deliver oil to the distribution center can include off-loading pumps, as described herein, to transfer oil to the bulk tanks at the distribution center into the upstream conduit 104.

In some aspects, the upstream conduit upstream section 108 includes a pressure exchanger. The pressure exchanger 112 (e.g., rotary pressure exchanger, etc.) is communicably coupled to the fluid delivery first controller 102 and is positioned within the upstream conduit upstream section 108. The fluid delivery first controller 102 operates the pressure exchanger 112 to facilitate a transfer of pressure energy between the fluid bulk transporter 110 and the upstream conduit upstream section 108 as the first fluid flows from the fluid bulk transporter 110 into the upstream conduit upstream section 108. The upstream conduit upstream section 108 includes an upstream conduit flow valve 114 (e.g., ball valve, gate valve, etc.). The upstream conduit flow valve 114 is configured to control the flow of the first fluid from the fluid bulk transporter 110. The upstream conduit flow valve 114 is positioned within the upstream conduit upstream section 108. In an aspect, the pressure exchanger 112 can be implemented via one or more pressure vessels provided with a check valve unit and a rotary valve. In an aspect, the pressure exchanger 112 can be implemented via one or more chambers and one or more cylindrical rotors.

The system 100 for storing a fluid includes an inlet control valve 116 (e.g., pneumatic valve, hydraulic ball valve, ball valve, control valve, etc.). The inlet control valve 116 is positioned within the upstream conduit upstream section 108 and communicably coupled to the fluid delivery first controller 102. In some aspects, the inlet control valve 116 is positioned downstream of the upstream conduit flow valve 114. The fluid delivery first controller 102 operates the inlet control valve 116 between a first position (e.g., closed position, etc.) and second position (e.g., open position, partially open position, etc.).

Specifically, when the inlet control valve 116 is operated, by the fluid delivery first controller 102, to a first position, flow of the first fluid is prohibited from flowing downstream of the upstream conduit upstream section 108. When the inlet control valve 116 is operated, by the fluid delivery first controller 102, to a second position, flow of the first fluid is facilitated downstream of the upstream conduit upstream section 108.

In some aspects, the system 100 for storing a fluid includes an upstream pressure instrument 118 (e.g., pressure gauge, etc.) as a first pressure instrument. The upstream pressure instrument 118 is positioned within the upstream conduit upstream section 108 and is configured to measure the pressure of the first fluid flowing downstream within the upstream conduit upstream section 108. In some aspects, the upstream pressure instrument 118 is positioned downstream of the inlet control valve 116. In some aspects, the system 100 for storing a fluid includes a first fluid upstream non-return valve 120 (e.g., check valve, one-way valve, retention valve, retainer, etc.). The first fluid upstream non-return valve 120 is positioned within the upstream conduit upstream section 108 and configured to prohibit the first fluid from flowing back upstream.

In an aspect, the upstream conduit upstream section 108 includes an upstream conduit downstream section 122. The upstream conduit downstream section 122 is fluidly coupled to the upstream conduit upstream section 108 and is configured to receive the first fluid and facilitate flow downstream. The system 100 for storing fluid includes a storage tank 106 (e.g. bulk storage tank, first fluid first storage tank). The storage tank 106 is fluidly coupled to the upstream conduit downstream section 122 and is configured to store the first fluid. Specifically, the storage tank 106 receives the first fluid from the upstream conduit downstream section 122 and stores the first fluid within a volume of the storage tank.

The size of storage tanks 106 is dependent on periodic demand (e.g., weekly) for oil at a given distribution center. The average requirement for a given distribution center may be, for example, for a tank capacity between 5,000 gallons and 10,000 gallons or between 5,000 gallons and 15,000 gallons. For example, the average requirement may be for 10,000 gallon tank, an 11,000 gallon tank, a 12,000 gallon tank, a 13,000 gallon tank, a 14,000 gallon tank, or a 15,000 gallon tank, although other sizes of tanks are contemplated and the foregoing examples of sizes are not intended to limit the scope of this disclosure.

According to an aspect, the storage tank 106 includes one or more level sensors 124 and one or more associated transmitters which may be provided with the one or more level sensors 124 and control functionality to ensure efficient operation and to provide safety measures (e.g., to provide an alarm when a level of fluid has been exceeded in a tank). One or more of the one or more level sensors 124 and one or more associated transmitters are configured to obtain measurements of the level of the first fluid within the storage tank. For example, the level sensors 124 and associated transmitters can be communicably coupled to the fluid delivery first controller 102 and configured to transmit, to the fluid delivery first controller 102, at least one signal corresponding to one or more measurements of the level of the first fluid within the storage tank. For example, one or more of the sensors 124 may be communicated with the transmitter which in turn communicates sensor information to the controller 102. In some aspects, control of sensors present in a bulk tank may be facilitated through the use of electrical connections running from a loading dock electrical connection site to a trailer. In this manner, control of sensors such as a high level sensor may be realized. In some aspects, such tanks and their associated sensors and control functionality are provided with spill containment features. Power may be supplied from DC electrical sources.

In some aspects, the system 100 for storing fluid further includes a fluid delivery second controller 126 (e.g., fill controller, etc.). In some aspects the fluid delivery second controller 126 is the same as the fluid delivery first controller 102. The system for storing fluid further includes a downstream conduit 128. The downstream conduit 128 includes a downstream conduit upstream section 130 fluidly coupled to the storage tank 106 and configured to transport the first fluid downstream. The downstream conduit upstream section 130 receives the first fluid from the storage tank 106 and transports the first fluid downstream. The system 100 for storing a fluid includes a first downstream conduit flow valve 132 (e.g., ball valve, etc.) configured to control the flow of the first fluid from the storage tank 106 into the downstream conduit 128. The system for storing a fluid includes an outlet control valve 134. The outlet control valve 134 is positioned within the downstream conduit upstream section 130 and is communicably coupled to the second fluid delivery controller 126. In some aspects, the outlet control valve 134 is positioned downstream of the first downstream conduit flow valve 132. The outlet control valve 134 is operated by the fluid delivery second controller 126 between a first position (e.g., a closed position, etc.) and a second position (e.g., an open position, a partially open position, etc.). Specifically, the fluid delivery second controller 126 operates the outlet control valve 134 to a first position to prohibit the flow of the first fluid downstream. In some aspects, the fluid delivery second controller 126 is further configured to operate the outlet control valve 134 to a second position to facilitate flow of the first fluid downstream.

The system 100 for storing fluid includes at least one pump 136 (e.g., centrifugal pump, motor pump, rotary pump, piston pump, gear pump with a motor, etc.). The pump 136 is positioned within the downstream conduit upstream section 130 and positioned downstream of the outlet control valve 134. The pump 136 is configured to receive the first fluid and to facilitate fluid transfer downstream of the downstream conduit upstream section 130. In some aspects, the pump 136 is communicably coupled to and operably by the fluid delivery second controller 126.

In addition, the downstream conduit 128 of the system for storing fluid includes a downstream conduit downstream section 138. The downstream conduit downstream section 138 is fluidly coupled to the downstream conduit upstream section 130 and is configured to receive the first fluid. Specifically, the fluid delivery second controller 126 operates the pump 136 such that the first fluid flows from the downstream conduit upstream section 130 into the downstream conduit downstream section 138.

In some aspects, the system 100 for storing fluid includes a fresh oil transfer system 140. The fresh oil transfer system 140 is designed to transfer oil from bulk tanks (e.g. storage tank 106, etc.) to the distribution center's delivery trucks 142 (e.g., transport systems, etc.).

The fresh oil transfer system 140 includes at least one discharge conduit 144. In some aspects, the fresh oil transfer system 140 includes a plurality of discharge conduits 144 (e.g., food grade hose, etc.). The plurality of discharge conduits 144 are fluidly coupled to the downstream conduit downstream section 138 and are configured to receive the first fluid. The plurality of discharge conduits 144 may include pump(s) valve(s) and accessories which may be communicably coupled to and operable by the fluid delivery second controller 126 to facilitate transfer of oil at a fluid flow rate within a given range, e.g., 5 -15 gallons per minute (GPM). In some aspects, each of the plurality of discharge conduits includes a discharge conduit control valve 146. The discharge conduit control valve 146 is positioned within the discharge conduit 144 and is communicably coupled to and operable by the fluid delivery second controller 126. The discharge conduit control valve 146 controls the flow of the fluid from the discharge conduit 144 to at least one of the plurality of delivery trucks 142. A desired flow rate may be achieved from the bulk tanks at a given number of loading docks at a site. Power may be supplied from a main electrical source and/or an auxiliary electrical source at a distribution center via a power conduit 145 (e.g., a cord, a cable, or via a wired or wireless charger).

In some aspects, the system 100 for storing fluid includes a recycle agitation system 148 (an agitator). The recycle agitation system 148 is configured to facilitate a portion of the first fluid in the downstream conduit downstream section 138 to flow towards the storage tank 106. The recycle agitation system includes a mixing conduit 150. The mixing conduit includes a first mixing conduit section 152 fluidly coupled to the downstream conduit downstream section 138. The mixing conduit 150 includes a second mixing conduit section 154 fluidly coupled at one end to the storage tank 106 and at a second end to the first mixing conduit section 152. The second mixing conduit section 154 is configured to receive the first fluid from the first mixing conduit section 152 and transfer the first fluid to the storage tank 106 to facilitate mixing of the first fluid. The recycle agitation system 148 includes a mixing conduit valve 156 (e.g., pneumatic valve, hydraulic ball valve, ball valve, control valve, etc.). The mixing conduit valve 156 is positioned between the first mixing conduit section 152 and the second mixing conduit section 154 and configured to facilitate flow of the fluid to the storage tank.

For example, in an aspect, the mixing conduit valve 156 is communicably coupled to and operable by the fluid delivery second controller 126. The mixing conduit valve 156 is operable between a between a first position (e.g., closed position, etc.) and second position (e.g., open position, partially open position, etc.). When the mixing conduit valve 156 is operated, by the fluid delivery second controller 126, to be in a first position, flow of the first fluid is prohibited from flowing to the second mixing conduit section 154. When the mixing conduit valve 156 is operated, by the fluid delivery second controller 126, to be in a second position, flow of the first fluid is facilitated from the downstream conduit downstream section 122 to the storage tank 106 via the mixing conduit 150.

Further, in some aspects, the recycle agitation system 148 includes a mixing conduit non-return valve 158. The mixing conduit non-return valve 158 is positioned downstream of the mixing conduit valve 156. The mixing conduit non-return valve 158 is substantially similar to the first fluid upstream non-return valve 120 in some aspects. The recycle agitation system 148 includes a mixing conduit flow control valve 160. The mixing conduit flow control valve 160 is positioned downstream of the mixing conduit non-return valve 158. The mixing conduit flow control valve 160 is substantially similar to the upstream conduit flow valve 114 in some aspects.

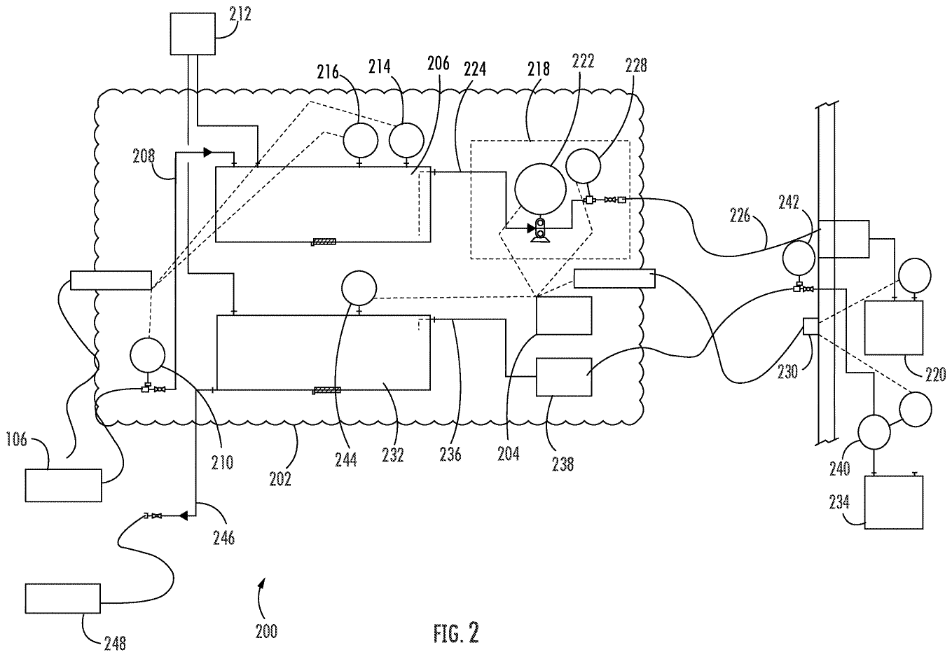

Referring to FIG. 2, a transport system 200 for delivering fluids (hereinafter “transport system”), according to one aspect, is shown. In some aspects, the transport system 200 may be a delivery truck or a delivery trailer for a distribution center. In some aspects, the transport system 200 may be the fluid bulk transporter 110. The transport system includes a chassis 202 (e.g., a base, frame, chassis of a delivery trailer, etc.). The transport system also includes a fluid transfer controller 204 (e.g., control interface, etc.) coupled to the chassis 202. The transport system 200 includes a first fluid storage tank 206 (e.g., bulk storage tank, fresh oil tank, a first fluid storage tank, a first fluid second tank etc.). The first fluid storage tank 206 is configured to be coupled to the chassis 202. In some aspects, the first fluid storage tank 206 is coupled to a bottom portion (e.g., underside, bottom, lower side etc.) of the chassis. In some aspects the first fluid storage tank 206 is coupled to a top or side portion (e.g., topside or upper-facing surface, etc.) of the chassis 202. According to the techniques discussed herein, the selection of the location for attachment points of the first fluid storage tank 206 at the underside may be made based on specific parameters. These parameters include allocation area, which may be limited, and support (attachment point) options. The allocation area corresponds to an available space for a fluid storage tank. The parameters may include a proximity to an attachment point (e.g., a distance between where the fluid storage tank is to be positioned and a support structure via which the fluid storage tank can be physically coupled to the chassis 202). Attachment points include, but are not limited to, channel iron bracing to be provided at the underside of a trailer. In some aspects, one or more attachment points may include such channel iron bracing, brackets, mounting points, quick-release connectors, or any combination of the foregoing.

The first fluid storage tank 206 is configured to receive and store the first fluid from the storage tank 106 (as shown in FIG. 1) of the system 100 for storing a fluid. Specifically, a first fluid inlet conduit 208 (e.g., food grade hose, etc.) is fluidly coupled at one end to at least one of the plurality of discharge conduits 144 of the system 100 for storing fluid and fluidly coupled to the first fluid storage tank 206 at a second end. As the fluid delivery second controller 126 of the system 100 for storing fluid operates the valves and pumps 146 positioned within the plurality of discharge conduits 144, flow of the first fluid is facilitated through the first fluid inlet conduit 208 to the first fluid storage tank 206. The first fluid storage tank 206 receives the first fluid and stores the first fluid.

In some aspects, the transport system 200 includes a first fluid storage tank pressure exchanger 210. The first fluid storage tank pressure exchanger 210 is electrically powered and is configured to facilitate a transfer of pressure energy between the first fluid storage tank 206 and the storage tank 106 of the system 100. The first fluid storage tank pressure exchanger 210 is positioned within the first fluid outlet conduit 208 between the first fluid storage tank 206 and the storage tank 106. The transport system 200 may include a vent 212. The vent 212 is fluidly coupled to the first fluid storage tank 206 via a conduit. The vent 212 is configured to facilitate the flow of air between the atmosphere and the first fluid storage tank 206.

In some aspects, the selection of the size of the first fluid storage tank 206 may be made in view of particular delivery schedule requirements to transport a given volume of oil (or a range based on an average volume up to a maximum volume) per delivery trip. Such a range may be, for example, between 1,000 to 1,200 lbs., 1,200 to 1,500 lbs., or 1,500 to 1,700 lbs. per week, for example. Fill piping may be installed to provide fluid transport from a connection at the back of a delivery truck to a trailer sidewall, and in turn to a small tank.

Various fluidic components may include nozzles which may be provided with standardized pipe threading. The nozzles may include a fill nozzle, a vent nozzle, a discharge nozzle, or a spare nozzle, or one or more of the foregoing, in any combination. Various sensors and valve components may include, for example, float switches with wiring that may complement the routing of the fill piping. In some aspects, the various sensors and valve components are communicably coupled to and operable by the fluid transfer controller 204 so as to facilitate and/or restrict flow of the first fluid from the first fluid storage tank.

In some aspects, the first fluid storage tank 206 may include a sensor 214 (e.g., a level sensor, etc.). The sensor 214 is electrically coupled to a power source and coupled to the first fluid storage tank 206. The sensor 214 is configured to measure the level of the fluid within the first fluid storage tank 206. The first fluid storage tank 206 may also include an alarm sensor 216 (e.g., liquid alarm high sensor, etc.). In some aspects, the sensor 214 and the alarm sensor 216 may be integrated and provided as one sensor. The alarm sensor 216 is electrically coupled to a power source and coupled to the first fluid storage tank 206. The alarm sensor 216 is configured to detect whether the level of fluid within the first fluid storage tank 206 is above (or alternatively, at or above) a predetermined threshold value. In some instances, the alarm sensor 216 is communicated with a controller configured to compare the detected fluid level to a predetermined threshold valve, where the controller is further configured to allow for calibration of the sensitivity of the alarm sensor 216 and/or setting of the predetermined threshold value.

In the event that the level of fluid is above the predetermined threshold value (or, alternatively, is at or above the predetermined threshold value), the alarm sensor 216 is configured to either provide an alert or communicate with a controller to cause an alert to be provided. The alert can be, for example, an audible alert, a visual alert (e.g., a written message, one or more flashing light emitting diodes (LED), or an audiovisual alert. By providing an alert in this manner, an operator can be notified as to a potential overfill and take corrective action (e.g., discharging an amount of liquid). Other alarm sensors set forth in this disclosure can be similarly configured. For example, where a leak sensor is provided, the leak sensor can be configured to provide an alert or communicate with a controller to cause an alert to be provided when a level of fluid is below a predetermined threshold (or, alternatively, at or below a predetermined threshold) or when fluid is being discharged at a given rate over a time interval. In some aspects, the alarm sensor 216 can be an abnormality sensor that is configured to provide an indication when a level of liquid is too high (indicative of a potential overfill) or too low (indicative of a potential leak).

In addition, the transport system 200 includes a pump metering system 218 for transferring fresh oil from a small delivery truck tank to an in-store system 220 (e.g., a first fluid storage location, etc.). Specifically, to facilitate delivery to the store, the pump metering system 218 includes a transport system pump 222 (e.g., motor-driven, rotary pump, etc.) that is fluidly coupled to the first fluid storage tank 206 via a first fluid outlet conduit 224 (e.g., food grade hose, etc.) at a first end and fluidly coupled to the in-store system 220 via a system first conduit 226 (e.g., food grade hose, etc.). The system first conduit 226 may be housed in a hose reel which is configured to extend and retract the system first conduit 226. The transport system pump 222 is communicably coupled to and operable by the fluid transfer controller 204. The fluid transfer controller 204 is configured to operate the transport system pump 222 to achieve a desired transfer rate (e.g., about 3 GPM to about 7 GPM, about 5 GPM, about 3 GPM to about 10 GPM, about 8 GPM). An average pumping time depends on the transfer rate and the delivery amount of fresh oil to be delivered. Further, the transport system 200 includes at least one flowmeter 228 (e.g., flow transmitter, flow indicator, flow controller, etc.). The flowmeter 228 is positioned within the first fluid outlet conduit 224 and may be configured to measure flow quantities and rates in real time and allow monitoring thereof. In some aspects, the flowmeter 228 is positioned between the first fluid outlet conduit 224 and the system first conduit 226. Further, the flowmeter 228 may be configured to communicate (e.g., wirelessly) with a computing system 230 (e.g., in-store computer terminal, mobile device, controller, etc.), through one or more delivery controllers. For example, the flowmeter 228 may be communicated with an in-store computer terminal 230 to communicate a transfer flow rate and/or total volume to the store. For example, a receipt or summary of delivery aspects (date, time) may be provided for printing in the store which may include the total volume delivered. In some aspects, the flowmeter 228 is communicably coupled to the fluid transfer controller 204 and configured to communicate a transfer flow rate and/or total volume.

Further, in some aspects, the transport system 200 includes a second fluid storage tank 232 (e.g., UCO tank, second fluid second storage tank, etc.). The second fluid storage tank 232 is configured to be coupled to the chassis 202. In some aspects, the second fluid storage tank 232 is configured to be coupled to a bottom portion (e.g., underside, bottom, underbelly, etc.) of the chassis 202. In some aspects, the second fluid storage tank 232 is coupled to a top portion (e.g., topside, overside, etc.) of the chassis 202. In some aspects, the second fluid storage tank 232 and/or the first fluid storage tank 206 are configured to be installed so as to connect or contact multiple surfaces (e.g., a side surface and a bottom surface) of a chassis 202 of a trailer.

In some aspects, the second fluid storage tank 232 is subject to similar placement constraints and attachment considerations as the first fluid storage tank 206. The second fluid storage tank 232 may be sized for maximum delivery schedule requirements. The second fluid storage tank 232 is fluidly coupled to a UCO source tank 234 (e.g., a second fluid storage location, etc.). Specifically, a second fluid inlet conduit 236 (e.g., a food grade hose, etc.) is fluidly coupled at one end to a UCO source tank 234 and at a second end to the second fluid storage tank 232. In some aspects, the second fluid inlet conduit 236 is fluidly coupled to a system second conduit 238 (e.g., food grade hose, etc.). The system second conduit 238 may be housed in a hose reel which is configured to extend and retract the system second conduit 238. Further, a load-out pump 240 is fluidly coupled to the UCO source tank 234 and is configured to transfer UCO from the UCO source tank 234 to the second fluid storage tank 232 via the second fluid inlet conduit 236. In some aspects, the second fluid inlet conduit 236 may be provided (e.g., at an outer wall of a facility, on the chassis of the transport system, etc.) to permit connection to the UCO source tank 234. In some aspects, the load-out pump 240 is fluidly coupled to the system second conduit 238 and facilitates the flow of the UCO to the second fluid storage tank 232 via the system second conduit 238 and the second fluid inlet conduit 236. The transport system 200 includes a system pressure exchanger 242. The system pressure exchanger 242 is electrically powered and is configured to facilitate a transfer of pressure energy between the system second conduit 238 and UCO source tank 234. In some aspects, the system pressure exchanger 242 is configured to facilitate a transfer of pressure energy between the UCO source tank 234 and the second fluid inlet conduit 236. The system pressure exchanger 242 is positioned within the system second conduit 238. In some aspects the pressure exchanger 242 is positioned within the second fluid inlet conduit 236.

The second fluid tank may include a second fluid tank sensor 244 (e.g., a level sensor, etc.). The second fluid tank sensor 244 is coupled to the second fluid tank and is configured to measure the level of the second fluid within the second fluid tank The transport system 200 may include a sensor suite or sensor array communicably coupled to the fluid transfer controller 204 to allow for obtaining measurements and to allow communication for interfacing the in-store system with the transport system, including but not limited to a first fluid storage tank high level sensor (e.g., sensor 214, etc.), an second fluid storage tank high level sensor (e.g., second fluid tank sensor 244, etc.), and a hose connection sensor.

The transport system 200 includes a second fluid outlet conduit 246 (e.g., food grade hose, etc.). The second fluid outlet conduit is fluidly coupled to the second fluid storage tank 232 and is configured to facilitate transport of the second fluid within the second fluid tank to a storage tank 248 for further processing and/or storing.

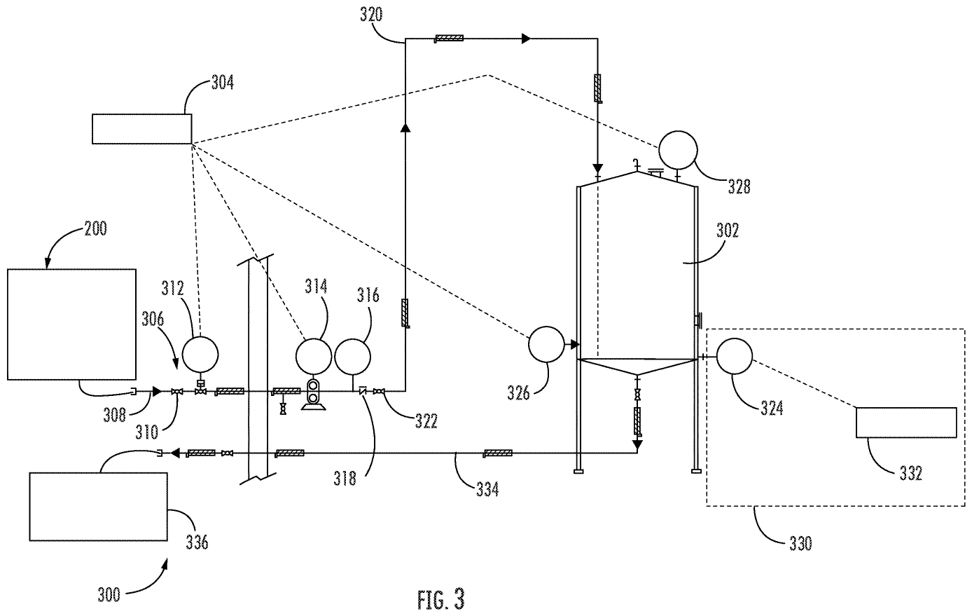

Referring to FIG. 3, a system 300 for storing a second fluid according to an aspect is shown. Specifically, once UCO is collected into the second fluid storage tank 232 located on the transport system 200, it may be unloaded into a second fluid first storage tank 302 (e.g., bulk UCO tank, waste fluid tank, etc.), as described herein. The system 300 for storing a second fluid includes the second fluid first storage tank 302. In some aspects, the second fluid first storage tank 302 is located at the distribution center. The second fluid first storage tank 302 is configured to store the second fluid received from the transport system 200.

The system 300 for storing the second fluid includes a second fluid delivery controller 304 (e.g., unload controller, etc.). In some aspects, the second fluid delivery controller 304 is the same as or can include similar functionality as the fluid delivery first controller 102. The system 300 for storing the second fluid includes a second fluid upstream conduit 306 (e.g., food grade hose, etc.). The second fluid upstream conduit 306 includes a second fluid upstream conduit upstream section 308. The second fluid upstream conduit upstream section 308 is fluidly coupled to the second fluid storage tank 232 on the transport system 200 and is configured to receive the second fluid. The second fluid upstream conduit upstream section 308 includes a second fluid upstream conduit first flow valve 310 (e.g., ball valve, etc.). The second fluid upstream conduit first flow valve 310 is configured to control the flow of the second fluid from the second fluid storage tank.

The system 300 for storing the second fluid includes a second fluid inlet control valve 312. The second fluid inlet control valve 312 is positioned within the second fluid upstream conduit upstream section 308. In some aspects, the second fluid inlet control valve 312 is positioned downstream of the second fluid upstream conduit first flow valve 310. The second fluid inlet control valve 312 may be communicably coupled to and operable by the second fluid delivery controller 304. Specifically, the second fluid delivery controller 304 operates the second fluid inlet control valve 312 between a first position (e.g., closed position, etc.) and second position (e.g., open position, partially open position, etc.). When the second fluid inlet control valve 312 is operated, by the second fluid delivery controller 304, to a first position, flow of the second fluid is prohibited from flowing downstream of the second fluid upstream conduit upstream section 308. When the second fluid inlet control valve 312 is operated, by the second fluid delivery controller 304, to a second position, flow of the second fluid is facilitated downstream of the second fluid upstream conduit upstream section 308.

The system 300 for storing a second fluid includes a second fluid pump 314 (e.g., a gear pump with a motor, a rotary pump, a fluid pump, etc.). The second fluid pump 314 is positioned in the second fluid upstream conduit upstream section 308. In some aspects, the second fluid pump 314 is positioned downstream of the second fluid inlet control valve 312. The second fluid pump 314, in some aspects, may be used to facilitate unloading from the second fluid storage tank 232 downstream of the second fluid upstream conduit upstream section 308.

Further, in some aspects, the system 300 for storing a second fluid may include a second fluid pressure instrument 316. The second fluid pressure instrument 316 may be positioned within the second fluid upstream conduit upstream section 308 and downstream of the second fluid pump 314. The second fluid pressure instrument 316 can be substantially similar to the upstream pressure instrument 118, as described above. In some aspects, the system 300 for storing fluid may include a second fluid non-return valve 318. The second fluid non-return valve 318 may be positioned within the second fluid upstream conduit upstream section 308 and downstream of the second fluid pressure instrument 316. The second fluid non-return valve 318 can be substantially similar to the first fluid upstream non-return valve 120.

In some aspects, the second fluid upstream conduit 306 of the system 300 for storing a second fluid include a second fluid upstream conduit downstream section 320. The second fluid upstream conduit downstream section 320 is fluidly coupled to the second fluid upstream conduit upstream section 308 and configured to receive the second fluid provided from the second fluid storage tank 232 of the transport system 200.

The system 300 for storing a second fluid includes a second fluid upstream conduit second flow valve 322. The second fluid upstream conduit second flow valve 322 is positioned within the second fluid upstream conduit downstream section 320. In some aspects, the second fluid upstream conduit second flow valve is positioned downstream of the second fluid non-return valve 318. The second fluid upstream conduit second flow valve 322 can be substantially similar to the second fluid upstream conduit first flow valve 310.

The system 300 for storing a second fluid includes a second fluid first storage tank 302 (e.g., bulk UCO tank, waste fluid tank, etc.). The second fluid first storage tank 302 is configured to receive the second fluid from the second fluid storage tank 232 of the transport system 200 and store the second fluid. Specifically, the second fluid first storage tank 302 is fluidly coupled to the second fluid upstream conduit downstream section 320 so as to receive the second fluid. In some aspects, the second fluid pump 314 transfers the fluid from the second fluid storage tank 232 to the second fluid first storage tank 302 via the second fluid upstream conduit 306.

As noted previously, size requirements can be dictated at least in part by scheduling needs. For example, in some aspects, the size of the second fluid first storage tank 302 is dependent on periodic supply (e.g., weekly) of oil from a plurality of restaurants. The average supply for a plurality of restaurants may be, for example, for a tank capacity between 5,000 gallons and 10,000 gallons or between 5,000 gallons and 15,000 gallons. For example, the average requirement may be for 10,000 gallon tank, an 11,000 gallon tank, a 12,000 gallon tank, a 13,000 gallon tank, a 14,000 gallon tank, or a 15,000 gallon tank, although other sizes of tanks are contemplated and the foregoing examples of sizes are not intended to limit the scope of this disclosure.

Further, the second fluid first storage tank 302 may include one or more level sensors, which may in some aspects be similar to the level sensor 124 of storage tank 106. For example, level sensor 124 may include a high level sensor, or a high level sensor may be provided separately. In some aspects, the level sensor 124 may have functionality to communicate with a controller to determine that a level of fluid is high. The level sensor 124 can also have one or more transmitters, e.g., for communication with one or more controls. In some aspects, the second fluid first storage tank 302 may further include control functionality to ensure efficient operation and to provide safety measures (e.g., to provide an alarm when a level of fluid has been exceeded in a tank). In some aspects, the level sensors are configured to obtain measurements of the level of the first fluid within the second fluid storage tank. Specifically, the one or more level sensors are communicably coupled to the fluid delivery second controller and are configured to provide the second fluid delivery controller 304 at least one signal corresponding to the measurements of the level of the second fluid within the second fluid first storage tank.

As seen in FIG. 3, the second fluid first storage tank 302 includes a level sensor 324. In some embodiments, the level sensor 324 includes an associated transmitter (which may be provided separately or integrated with the sensor). The level sensor 324 is coupled to the second fluid first storage tank 302 and is configured to measure the level of the second fluid within the second fluid first storage tank 302. The second fluid first storage tank 302 includes a level transmitter 326. The level transmitter is coupled to the second fluid first storage tank 302. The level transmitter 326 is communicably coupled to the second fluid delivery controller 304 and is configured to transmit the level of the fluid within the second fluid first storage tank 302 to the second fluid delivery controller 304. In some aspects, the level transmitter 326 is configured to transmit the level of fluid within the second fluid first storage tank 302 to the first storage tank alarm sensor 328. In some aspects, the level transmitter 326 and the alarm sensor 328 may be integrated and provided as a single sensor. The second fluid first storage tank 302 includes first storage tank alarm sensor 328. The first storage tank alarm sensor 328 is coupled to the second fluid first storage tank 302 and communicably coupled to the second fluid delivery controller 304. The first storage tank alarm sensor 328 is configured to transmit an alert to the second fluid delivery controller 304 so as to notify an operator that the fluid in the second fluid first storage tank 302 is above a predetermined threshold.

In some aspects, control of sensors present in a bulk tank may be facilitated through the use of electrical connections running from a loading dock electrical connection site to a trailer. In this manner, control of sensors such as a high level sensor may be realized. In some aspects, such tanks and their associated sensors and control functionality are provided with spill containment features. For example, in some aspects, the second fluid first storage tank may include a leak detection system 330. The leak detection system 330 may include an alarm 332 to notify the identification of a leak. In operation, the level sensor 324 measures the level of fluid within the second fluid first storage tank 302 at various times (e.g., at regular intervals). When the level sensor 324 detects that the level of fluid is reducing based on the multiple measurements taken over a time period, the alarm 332 is triggered to notify an operator of a potential leak. The alarm functionality may be similar to that described above for alarm sensor 216. In some aspects, power to one or more components, such as the alarm, may be supplied from DC electrical sources.

Further, in some aspects, the system 300 for storing a second fluid includes a second fluid downstream conduit 334. The second fluid downstream conduit 334 is fluidly coupled to the second fluid first storage tank 302 and is configured to transfer the second fluid from the second fluid first storage tank 302 to waste hauling tankers 336 (waste hauling transporters). Specifically, control systems of the waste hauling transporter facilitate flow from the second fluid first storage tank 302 to the waste hauling tanker 336 via the second fluid downstream conduit 334.

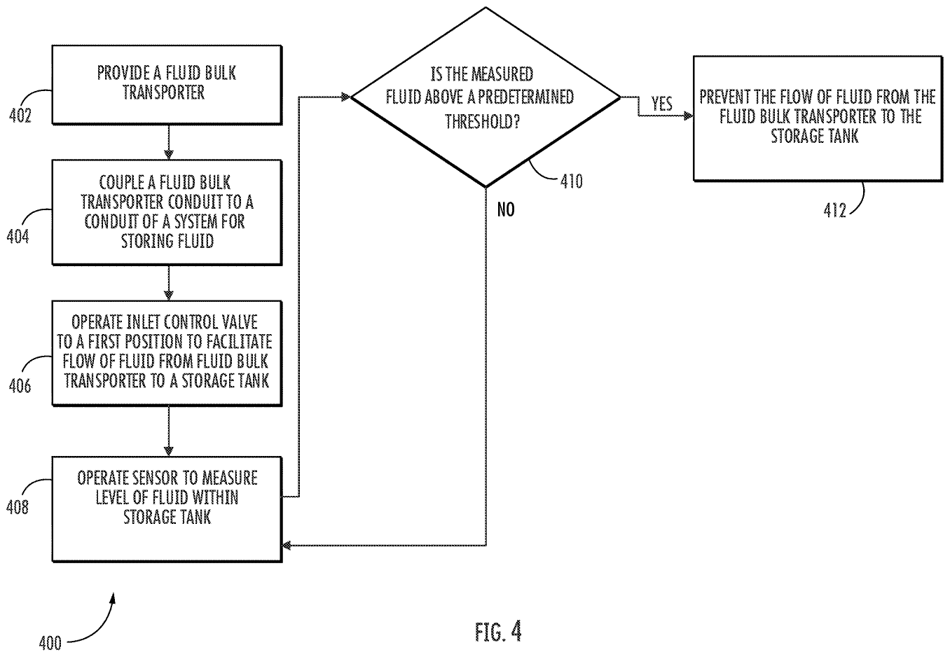

Referring to FIG. 4, a block diagram of a method 400 for delivering fluid (e.g., edible oil, etc.) to a distribution center is shown. In step 402 a fluid bulk transporter (e.g. a fluid bulk transporter 110, etc.) is provided. The fluid bunk transporter is configured to store fluid and transport it between locations (e.g., from a production source to a distribution center). In step 404, a fluid bulk transporter conduit is coupled to a conduit of a system (e.g., upstream conduit 104, downstream conduit 128, etc.) for storing the fluid which is located at the distribution center. Specifically, the fluid bulk transporter conduit is fluidly coupled to an upstream portion of the conduit (e.g., upstream conduit 104, etc.) so as to facilitate flow of fluid from the fluid bulk transporter to the system. In operation, a pump located on the fluid bulk transporter is actuated (e.g., operated through an electronic controller or manually) so that fluid flows from the fluid bulk transporter conduit. In step 406, an inlet control valve (e.g., inlet control valve 116, etc.) is operated to be in a first position by a fluid delivery first controller (e.g., fluid delivery first controller 102, etc.). In the first position, the inlet control valve is configured to facilitate flow of fluid from the fluid bulk transporter through the conduit and toward a storage tank (e.g., storage tank 106, etc.). In step 408, one or more sensors (e.g., level sensors 124, etc.) and/or one or more transmitters (which may be integrated with the one or more sensors or provided separately) are operated to measure the level of fluid within a storage tank and transmit the measurements to the fluid delivery first controller. In step 410, the fluid delivery first controller receives the level of fluid measured, from the one or more sensors and determines whether the measurement of the fluid within the storage tank is above (or, alternatively, at or above) a predetermined threshold. If the fluid delivery first controller does not determine that the fluid is above a predetermined threshold, the method 400 reverts to step 410. If the fluid delivery first controller determines that the fluid detected by the sensors is above (or, alternatively, at or above) a predetermined threshold, the method 400 proceeds to step 412. In step 412, the fluid delivery first controller operates the inlet control valve to a second position to prevent the flow of fluid from the fluid bulk transporter.

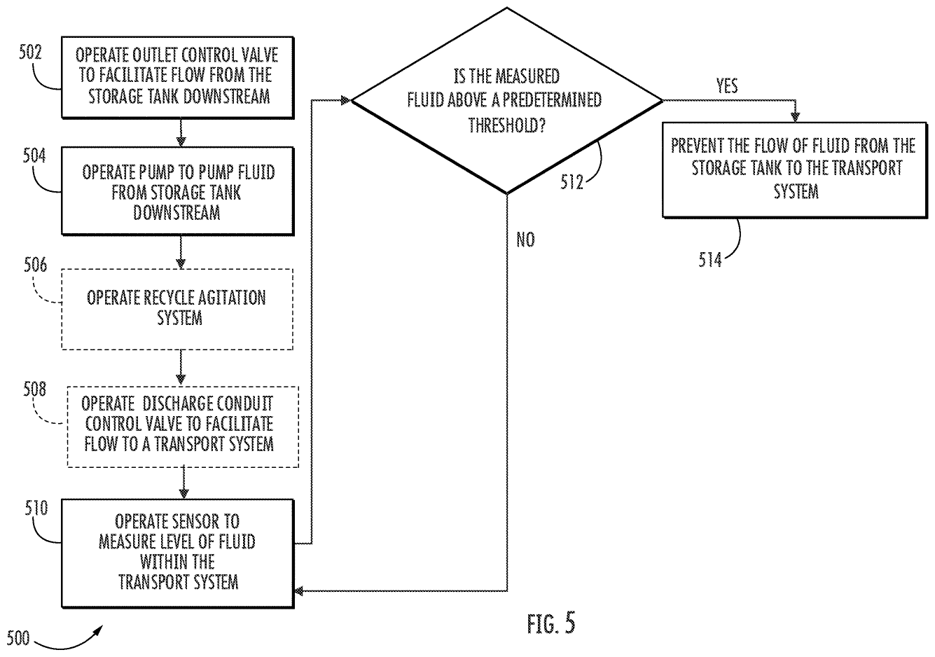

Referring to FIG. 5, a block diagram for a method 500 for delivering fluid from a distribution center to a distribution center transport system. In step 502, a fluid delivery second controller (e.g., fluid delivery second controller 126, etc.) operates an outlet control valve (e.g., outlet control valve 134, etc.) from a first position to a second position to facilitate the flow of the fluid from the storage tank downstream. As the outlet control valve is operated to be in a second position, such that fluid may flow from the storage tank into a downstream conduit (e.g., downstream conduit 128, etc.). In step 504, a pump (e.g., pump 136, etc.) is operated by the fluid delivery second controller. As the pump is operated, fluid is drawn from the storage tank and into the downstream conduit. Fluid is further pumped into at least one discharge conduit (e.g., discharge conduit 144, etc.). In some aspects, the fluid is pumped into one or more of a plurality of discharge conduits.

In some aspects, the method 500 may include one or more additional operations. For example, in some aspects, the method 500 may further include step 506. In step 506, the fluid delivery second controller operates a recycle agitation system (e.g., recycle agitation system 148, etc.) to facilitate mixing of the fluid. The fluid delivery second controller operates a mixing conduit valve (e.g., mixing conduit valve 156, etc.) from a first position to be in a second position. In the second position, the mixing conduit valve is configured to facilitate flow from the downstream conduit into a mixing conduit (e.g., mixing conduit 150, etc.). The mixing conduit is fluidly coupled at one end to the downstream conduit and is configured to receive the fluid from the downstream conduit when the mixing conduit valve is in the second position. The mixing conduit at a second end is fluidly coupled to the storage tank. The fluid flows into the mixing conduit toward the storage tank. In this manner, the fluid is being recirculated and mixed.

In some aspects, the method 500 further includes step 508. In step 508, the fluid delivery second controller operates a discharge conduit control valve (e.g., discharge conduit control valve 146, etc.,) from a first position to a second position to facilitate the flow of fluid from the discharge conduit to a transport system (e.g., transport system 200, etc.). The fluid flows from the downstream conduit into the discharge conduit and into a first fluid storage tank (e.g., first fluid storage tank 206, etc.) coupled to the transport system. In some aspects, fluid flows into a plurality of discharge conduits and the fluid delivery second controller is configured to operate a plurality of discharge conduit valves from a first position to a second position to facilitate flow into a plurality of first fluid storage tanks coupled, where each of the first fluid storage tanks are coupled to a transport system. In step 510, one or more sensors and/or one or more transmitters (e.g., the level sensor, the high level sensor, and one or more level transmitters) are operated to measure the level of fluid within the transport system and transmit the measurements to the fluid delivery second controller. In step 512, the fluid delivery second controller receives the level of fluid measured, from the sensors and determines whether the measurement of the fluid within the first fluid storage tank of the transport system is above a predetermined threshold. If the fluid delivery second controller does not determine that the fluid is above a predetermined threshold (or alternatively, at the predetermined threshold), the method 500 reverts to step 510. If the fluid delivery second controller determines that the fluid detected by the sensors is above a predetermined threshold, the method 500 proceeds to step 514. In step 514, the fluid delivery second controller operates the discharge conduit control valve to a second position to prevent the flow of fluid from the storage tank to the first fluid storage tank of the transport system.

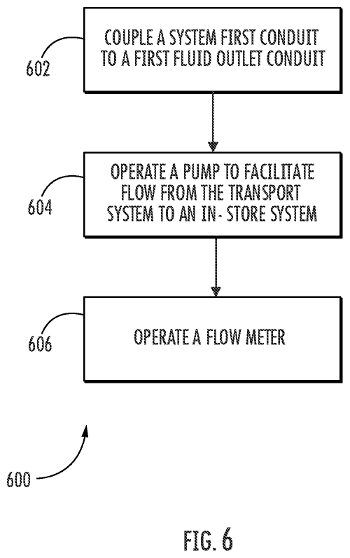

Referring to FIG. 6, a block diagram of a method 600 for delivering fluid from a transport system (e.g., transport system 200, etc.) to an in-store system is depicted. In step 602, a system first conduit (e.g., system first conduit 226, etc.) is connected to a first fluid outlet conduit (e.g., first fluid outlet conduit 208, etc.) such that fluid may flow from a transport system to an in-store system. In step 604, a fluid transfer controller (e.g. fluid transfer controller 204, etc.) operates a transport system pump (e.g., transport system pump 222, etc.) which is configured to pump the fluid from a first fluid storage tank on the transport system into the first fluid outlet conduit and towards the system first conduit. In step 606, the fluid transfer controller operates a flow meter to measure the flow of the fluid through the first fluid outlet conduit and the system first conduit. The fluid transfer controller receives the measurement and operates the pump to alter the flow rate of the fluid to a predetermined rate. In this manner, the fluid flows from the first fluid storage tank on the transport system to the in-store system.

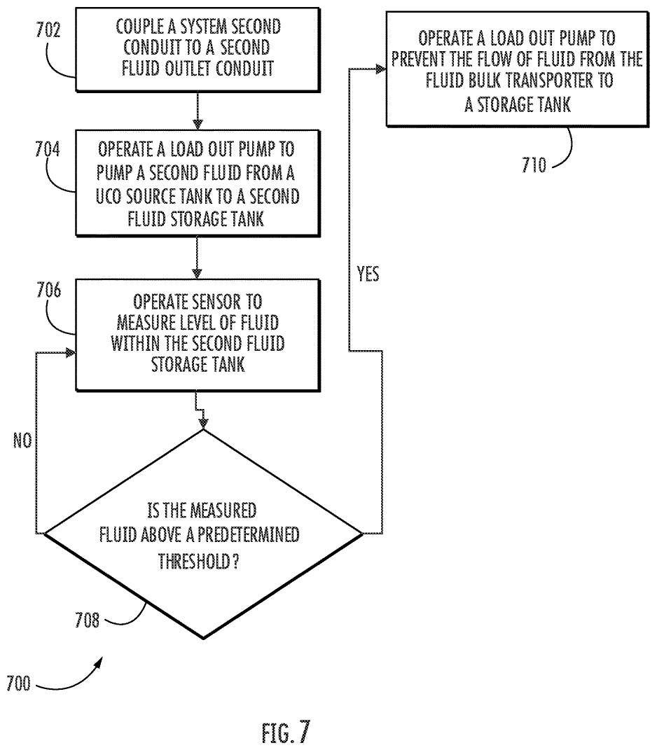

Referring to FIG. 7, a block diagram of a method 700 for delivering a second fluid from a UCO source tank (e.g., UCO source tank 234, etc.) to a second fluid storage tank (e.g., second fluid storage tank 232, etc.) on a transport system is depicted. In step 702, a system second conduit (e.g., second conduit 238, etc.) is coupled at one end to a UCO source tank and coupled to the second fluid storage tank at a second end. The coupling facilitates flow from a UCO source tank to the second fluid storage tank. In step 704, a fluid transfer controller (e.g., fluid transfer controller 204, etc.) operates a load-out pump (e.g., load-out pump 240, etc.) in order to pump a second fluid (e.g., used cooking oil, etc.) from the UCO source tank to the second fluid storage tank on the transport system. The pump pumps the fluid from the system second conduit to a second fluid inlet conduit (e.g. second fluid inlet conduit 238, etc.). The second fluid inlet conduit is fluidly coupled to second fluid storage tank such that the second fluid flows from the second fluid inlet conduit into the second fluid storage tank.

Referring still to FIG. 7, in step 706, one or more sensors and/or one or more transmitters (e.g., the level sensor, the high level sensor, and the level transmitters, second fluid tank sensor 244, etc.) are operated to measure the level of fluid within the transport system and transmit the measurements to the fluid delivery second controller. In step 708, the fluid transfer controller receives the level of fluid measured from the one or more sensors and determines if the measurement of the fluid in the second fluid storage tank is at or above a predetermined threshold. If the fluid transfer controller does not determine that the fluid is above a predetermined threshold, the method 700 reverts back to step 706. If the fluid transfer controller determines that the fluid detected by the sensors is above a predetermined threshold, the method 700 proceeds to step 710. In step 710, the fluid transfer controller operates the pump to an off position to prevent the flow of the second fluid from the UCO source tanks to the second fluid storage tank.

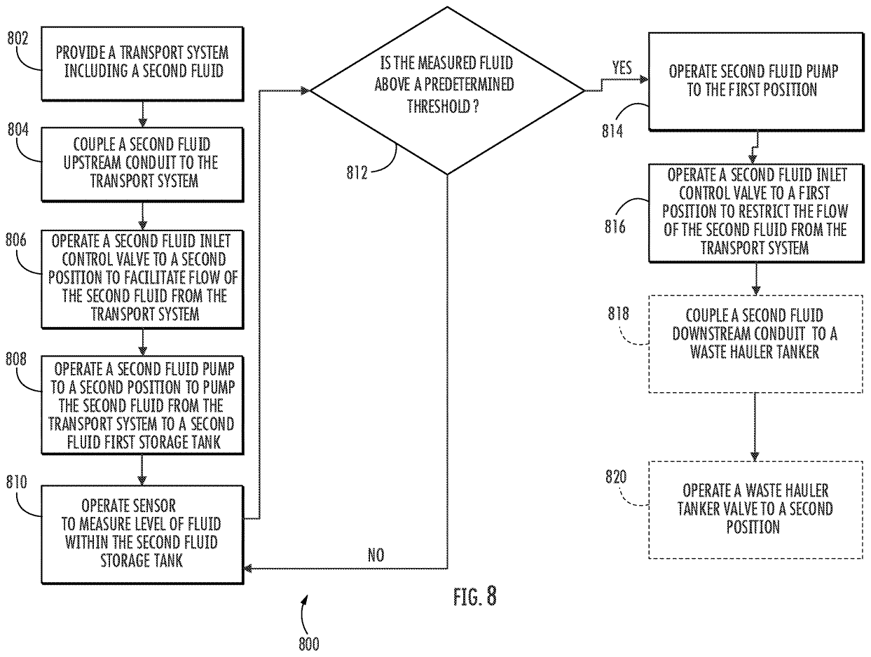

Referring to FIG. 8, a block diagram of a method 800 for delivering a second fluid to a waste hauling tanker (e.g., waste hauling tanker 336, etc.) is depicted. In step 802, a transport system including a second fluid is provided. In step 804, a second fluid upstream conduit (e.g., second fluid upstream conduit 308, etc.) of a system for storing a second fluid is coupled to the transport system. In step 806, a second fluid inlet control valve (e.g., second fluid inlet control valve 312, etc.) is operated from a first position to a second position to facilitate flow of the second fluid from the transport system to a second fluid first storage tank. The second fluid inlet control valve is operated by a second fluid delivery controller from the first position to the second position. In step 808, a second fluid pump is operated by the second fluid delivery controller from a first position to a second position (e.g., an “on” position, etc.) so as to pump the second fluid from the transport system to the second fluid first storage tank (e.g., second fluid first storage tank 302, etc.) via the second fluid conduit of the system for storing a second fluid. The second fluid is stored within the second fluid storage tank. In step 810, one or more sensors and/or one or more transmitters (e.g., the level sensor, the high level sensor, and level transmitters) are operated to measure the level of fluid within the second fluid first storage tank and to transmit the measurements to a second fluid delivery controller (e.g., second fluid delivery controller 304, etc.).

In step 812, the second fluid delivery controller receives the level of fluid measured, from the sensors and determines whether the measurement of the fluid within the second fluid first storage tank is above a predetermined threshold. If the second fluid delivery controller does not determine that the fluid is above a predetermined threshold, the method 800 reverts to back to step 810. If the second fluid delivery controller determines that the fluid detected by the sensors is above a predetermined threshold, the method 800 proceeds to step 814. In step 814 a second fluid pump (e.g., second fluid pump 314, etc.) is operated to the first position (e.g., an “off” position, etc.) so as to prevent the pump from pumping the second fluid. In step 816, the second fluid delivery controller operates second fluid inlet control valve from the second position to the first position to prevent the flow of the second fluid from the transport system to the second fluid first storage tank. In some aspects, the method 800 includes step 818. In step 818, a second fluid downstream conduit (e.g., second fluid downstream conduit 334, etc.) is coupled to the waste hauling tanker. The method 800 may include step 820. In step 820, a waste hauling tanker valve is operated by a waste hauling tanker controller from a first position to a second position to facilitate flow from the second fluid first storage tanker to the waste hauling tanker via the second fluid downstream conduit.

According to an aspect, a system for storing fluid includes a fluid delivery controller; a storage tank for storing a fluid and configured to be communicated with the fluid delivery controller, and conduits. The conduits include an upstream conduit, a downstream conduit, and a plurality of discharge conduits. The upstream conduit is fluidly coupled to the storage tank and configured to transport the fluid from an upstream location to the storage tank. The downstream conduit is fluidly coupled to the storage tank and is configured to transport the fluid from the storage tank. The plurality of discharge conduits are fluidly coupled to the downstream conduits and configured to receive the fluid from the storage tank and configured to provide the fluid to a system downstream of the plurality of discharge conduits.

The upstream conduit comprises an upstream conduit upstream section; and an upstream conduit downstream section, and the downstream conduit comprises a downstream conduit upstream section fluidly coupled to the storage tank; and a downstream conduit downstream section fluidly coupled to the plurality of discharge conduits.

The system for storing fluid further includes a first valve positioned within the upstream conduit upstream section and configured to receive the fluid, the first valve communicably coupled to and operable between a first position and a second position by the fluid delivery controller to prohibit the flow to the upstream conduit downstream section in the first position and facilitate flow to the upstream conduit downstream section; a second fluid valve positioned within the downstream conduit upstream section and configured to receive the fluid from the storage tank, the first valve communicably coupled to and operable between a first position and a second position by the fluid delivery controller to prohibit the flow to the downstream conduit downstream section and facilitate flow to the downstream conduit downstream section; and a pump fluidly coupled to the downstream conduit downstream section, the pump configured to transport the fluid to the plurality of discharge conduits.

The system for storing fluid further includes a level sensor communicable with the fluid delivery controller and coupled to the storage tank, the level sensor configured to measure a fluid level of the fluid within the storage tank and communicated with a transmitter to cause a signal corresponding to the measurement to be provided to the fluid delivery system controller. The fluid delivery controller receives the signal corresponding to the fluid level and operates the first valve from the second position to the first position so as to prohibit the flow of fluid to the upstream conduit downstream section.

In the foregoing system, each of the plurality of discharge conduits includes a discharge valve, the discharge valve configured to receive fluid from the downstream conduit downstream section and communicably coupled to and operable between a first position and second position by the fluid delivery controller to prohibit fluid flow.

The system for delivering fluid includes a mixing conduit including a first mixing conduit section fluidly coupled to the downstream conduit downstream section, a second mixing conduit section fluidly coupled to the storage tank and positioned downstream of the first mixing conduit section; and a mixing conduit valve fluidly coupled to and positioned between the first mixing conduit and the second mixing conduit, the mixing conduit communicable with and operable between a first position and a second position by the fluid delivery controller to facilitate flow of fluid between the first mixing conduit and the second mixing conduit to the storage tank.

Another aspect relates to a transport system for delivering fluids, the transport system comprising a chassis; a first fluid storage tank positioned on and coupled to the chassis and configured to receive first fluid; a first fluid outlet conduit fluidly coupled to the first fluid storage tank and receiving the first fluid from the storage tank to provide to a first fluid storage location; a second fluid storage tank positioned on and coupled to the chassis and configured to receive second fluid from a second fluid storage location; and a second fluid inlet conduit fluidly coupled to the waste fluid storage tank and receiving the second fluid from a second fluid storage location and providing to the second fluid storage tank.

In such a transport system, the first fluid is fluid having first characteristics, and the second fluid is fluid having second characteristics differing from the first characteristics. For example, the first fluid is fresh fluid and the second fluid is waste fluid. In particular, the first fluid may have first characteristics including a first quantity of degradation compounds, and the second fluid may have second characteristics including a second quantity of degradation compounds higher than the first quantity.

The transport system for delivering fluids also includes a first fluid inlet conduit fluidly coupled to the first fluid storage tank and providing the first fluid storage tank with first fluid from another first fluid storage location; and a waste fluid outlet conduit fluidly coupled to the waste fluid storage tank and providing a second waste fluid location to receive the waste fluid from the waste fluid storage tank.

In such a transport system, the first fluid outlet conduit, the first fluid inlet conduit, the waste fluid inlet conduit, and the waste fluid outlet conduit comprise food grade hose for transporting food based media, e.g., edible oil (such as fresh or used cooking oil).

The first fluid outlet conduit comprises a fluid transfer controller coupled to the chassis; an upstream first fluid outlet section configured to receive first fluid from the first fluid storage tank; a downstream first fluid outlet section positioned downstream of the upstream first fluid outlet section; and a pump fluidly coupled to the upstream first fluid outlet section and the downstream first fluid outlet section and communicably coupled to and operable by the fluid transfer controller to receive the first fluid from the upstream first fluid outlet section and facilitate flow to the downstream first fluid outlet section.

In some aspects, the transport system further includes a second fluid level sensor coupled to the second fluid storage tank and communicable with the fluid transfer controller, the second fluid level sensor configured to provide a signal corresponding to a measurement of the second fluid level to the fluid transfer controller; and the fluid transfer controller is further configured to receive the signal corresponding to the measurement of the second fluid level; determine the measurement of the second fluid level within the second fluid storage tank based on the signal; determine whether the measurement is equal to or greater than a threshold second fluid level; and operate a second fluid pump to prohibit flow of the second fluid to the second fluid storage tank.

Another aspect relates to a system for delivering fluid. The system includes a storage system for storing fluid including a first fluid first storage tank configured to store the first fluid; an upstream conduit fluidly coupled to the first fluid first storage tank and configured to transport the first fluid from an upstream location to the first fluid first storage tank; a downstream conduit fluidly coupled to the first fluid first storage tank, the downstream conduit configured to transport the first fluid from the first fluid first storage tank; and a plurality of discharge conduits fluidly coupled to the downstream conduits, the plurality of discharge conduits configured to receive the first fluid from the first fluid first storage tank and configured to provide the first fluid to a system downstream of the plurality of discharge conduits; and a second fluid first storage tank. The system further includes a transport system for delivering fluid comprising a chassis; a first fluid second storage tank positioned on and coupled to the chassis and configured to receive first fluid from the first fluid first storage tank; a first fluid outlet conduit fluidly coupled to at least one of the plurality of discharge conduits and to the first fluid second storage tank, the first fluid outlet conduit configured to receive first fluid from the at least one of the plurality of discharge conduits and provide the first fluid to the first fluid second storage tank; a second fluid second storage tank positioned on and coupled to the chassis and configured to discharge second fluid to the second fluid first storage tank; and a second fluid outlet conduit fluidly coupled to the second fluid first storage tank and the second fluid storage tank, the second fluid outlet conduit configured to receive second fluid from the second fluid second storage tank and provide the second fluid to the second fluid first storage tank.

In some aspects, the system includes a sensor array configured to measure a fluid amount and one or more operational parameters at one or both of the upstream conduit and the downstream conduit. The sensors may include a flowmeter positioned at one or both of the upstream conduit and the downstream conduit. One or more leak detection sensors may be provided.

Various hosing and conduits, as described herein may be provided, e.g., 1″ food grade hose, 1.5″ food grade hose, etc. to deliver oil, although other sizes may be utilized.

Various fluid controllers, as described herein may include a processing circuit. The processing circuit may include a processor and a memory. The processor may be a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing a processor, ASIC, FPGA, etc. with program instructions. The memory may further include a memory chip, Electrically Erasable Programmable Read-Only Memory (EEPROM), Erasable Programmable Read Only Memory (EPROM), flash memory, or any other suitable memory from which the controller can read instruction. The instructions may include code from any suitable programming language.

Various numerical values herein are provided for reference purposes only. Unless otherwise indicated, all numbers expressing quantities of properties, parameters, conditions, and so forth, used in the specification and claims are to be understood as being modified in all instances by the term “approximately.” Accordingly, unless indicated to the contrary, the numerical parameters set forth in the following specification and attached claims are approximations. Any numerical parameter should at least be construed in light of the number reported significant digits and by applying ordinary rounding techniques. The term “approximately” when used before a numerical designation, e.g., a quantity and/or an amount including range, indicates approximations which may vary by (+) or (−) 10%, 5%, or 1%.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

It should be noted that the term “example” as used herein to describe various aspects is intended to indicate that such aspects are possible examples, representations, and/or illustrations of possible aspects (and such term is not intended to connote that such aspects are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed (e.g., within plus or minus five percent of a given angle or other value) are considered to be within the scope of the invention as recited in the appended claims.

The terms “coupled,” “connected,” and the like as used herein mean the joining of two members directly or indirectly to one another. Coupling may be electrical, mechanical and/or fluidic. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary aspects are illustrative only. Although only a few aspects have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary aspects without departing from the scope of the aspects described herein.

Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A transport system for delivering fluids, the transport system comprising:
a chassis configurable as a frame of a vehicle;
a first fluid storage tank positioned on and coupled to the chassis and configured to receive a first fluid;
a first fluid outlet conduit fluidly coupled to the first fluid storage tank and configured to receive the first fluid from the storage tank to provide the first fluid to a first fluid storage location;
a second fluid storage tank positioned on and coupled to the chassis and configured to receive a second fluid from a second fluid storage location; and
a second fluid inlet conduit fluidly coupled to the second fluid storage tank and configured to receive the second fluid from the second fluid storage location and provide the second fluid to the second fluid storage tank.

2. The transport system of claim 1, wherein the first fluid is a fresh edible oil.

3. The transport system of claim 2, wherein the second fluid is a used edible oil.

4. The transport system of claim 1, wherein the vehicle is a delivery trailer, and each of the first fluid storage tank and the second fluid storage tank is configured to be coupled to an underside of the chassis.

5. The transport system for delivering fluids of claim 1, further comprising:
a first fluid inlet conduit fluidly coupled to the first fluid storage tank and configured to provide the first fluid storage tank with first fluid from another first fluid storage location; and
a second fluid outlet conduit fluidly coupled to the second fluid storage tank and configured to provide a second fluid location to receive the second fluid from the second fluid storage tank.

6. The transport system for delivering fluids of claim 5, wherein the first fluid outlet conduit, the first fluid inlet conduit, the second fluid inlet conduit, and the second fluid outlet conduit each comprise food grade hose.

7. The transport system for delivering fluids of claim 1, wherein the first fluid outlet conduit comprises:
a fluid transfer controller coupled to the chassis; an upstream first fluid outlet section configured to receive first fluid from the first fluid storage tank;
a downstream first fluid outlet section positioned downstream of the upstream first fluid outlet section; and
a pump fluidly coupled to the upstream first fluid outlet section and the downstream first fluid outlet section and communicably coupled to and operable by the fluid transfer controller to receive the first fluid from the upstream first fluid outlet section and to facilitate flow to the downstream first fluid outlet section.

8. The transport system for delivering fluids of claim 7, further comprising:
a second fluid storage tank level sensor coupled to the second fluid storage tank and communicable with the fluid transfer controller, the second fluid level sensor configured to provide a signal corresponding to a measurement of the second fluid level to the fluid transfer controller; and
the fluid transfer controller further configured to:
receive the signal corresponding to the measurement of the second fluid level;
determine the measurement of the second fluid level within the second fluid storage tank based on the signal;
determine whether the measurement is equal to or greater than a threshold waste fluid level; and
operate a second fluid pump to prohibit flow of the second fluid to the second fluid storage tank.

9. A method of retrofitting a delivery trailer to provide the transport system of claim 1, comprising:
installing, on an underside of the chassis, the first fluid storage tank;
installing, on the underside of the chassis, the second fluid storage tank;
coupling the first fluid outlet conduit to the first fluid storage tank; and
coupling the second fluid inlet conduit to the second fluid storage tank.

10. The method of claim 9, further comprising transporting the first fluid in the first fluid storage tank or the second fluid in the second fluid storage tank to or from a restaurant and a distribution center.

11. The method of claim 9, further comprising selecting, based on one or more parameters, a location on the underside of the chassis for installation of one of the first fluid storage tank or the second fluid storage tank.

12. The method of claim 11, wherein the one or more parameters include (i) an allocation area of available space on the underside and (ii) a proximity to an attachment point at which the one of the first fluid storage tank or the second fluid storage tank is coupled to the chassis.

13 .A system for delivering a fluid comprising:
a storage system comprising
a first fluid first storage tank configured to store a first fluid;
an upstream conduit fluidly coupled to the first fluid first storage tank and configured to transport the first fluid from an upstream location to the first fluid first storage tank;
a downstream conduit fluidly coupled to the first fluid first storage tank, the downstream conduit configured to transport the first fluid from the first fluid first storage tank; and
a plurality of discharge conduits fluidly coupled to the downstream conduits, the plurality of discharge conduits configured to receive the first fluid from the first fluid first storage tank and configured to provide the first fluid to a system downstream of the plurality of discharge conduits; and
a second fluid first storage tank; and
a transport system for delivering fluids comprising:
a chassis;
a first fluid second storage tank positioned on and coupled to the chassis and configured to receive the first fluid from the first fluid first storage tank;
a first fluid outlet conduit fluidly coupled to at least one of the plurality of discharge conduits and to the first fluid second storage tank, the first fluid outlet conduit configured to receive first fluid from the at least one of the plurality of discharge conduits and provide the first fluid to the first fluid second storage tank;
a second fluid second storage tank positioned on and coupled to the chassis and configured to discharge second fluid to the second fluid first storage tank; and
an second fluid outlet conduit fluidly coupled to the second fluid first storage tank and the second fluid second storage tank, the second fluid outlet conduit configured to receive second fluid from the second fluid second storage tank and provide the second fluid to the second fluid first storage tank.

14. The system of claim 13, further comprising a sensor array configured to measure a fluid amount and one or more operational parameters at one or both of the upstream conduit and the downstream conduit.

15. The system of claim 13, further comprising a flowmeter positioned at one or both of the upstream conduit and the downstream conduit.

16. The system of claim 15, wherein the first fluid first storage tank and the second fluid first storage tank are bulk storage tanks configured to store the first fluid and the second fluid, respectively, and each of the first fluid storage tank and the second fluid storage tank has a volumetric capacity between about 50 gallons to about 100 gallons.

17. The system of claim 13, wherein the first fluid is a fresh edible oil and the second fluid is used edible oil.

18. The system of claim 13, wherein the first fresh fluid is a fresh edible oil.

19-26. (canceled)
